(19) United States
(12) Patent Application Publication
(10) Pub. No.: US 2026/0279865 A1
(43) Pub. Date: Sep. 17, 2026

(54) MEMBRANE ELECTRODE ASSEMBLY AND METHOD FOR PRODUCING SAME, FUEL CELL, AND ELECTROLYSIS CELL

(71) Applicant: Greenerity GMBH, Alzenau (DE)

(72) Inventors: Alessandro Ghielmi, Frankfurt am Main (DE); Jozsef Speder, Frankfurt am Main (DE); Daniel Göhl, Mainhausen (DE)

(73) Assignee: Greenerity GMBH, Alzenau (DE)

(21) Appl. No.: 19/469,012

(22) PCT Filed: Mar. 26, 2024
(86) PCT No.: PCT/EP2024/058104

§ 371 Date: Sep. 25, 2025

(30) Foreign Application Priority Data
Mar. 27, 2023 (DE) 10 2023 107 646.9

(51) Int. Cl. H01M 8/1004; C25B 1/04; C25B 9/23; C25B 11/054; C25B 11/065; C25B 11/081; C25B 13/07; C25B 13/08; H01M 4/92; H01M 8/10; H01M 8/1023; H01M 8/1039; H01M 8/1041; H01M 8/1051

(52) U.S. Cl. CPC H01M 8/1004; C25B 1/04; C25B 9/23; C25B 11/054; C25B 11/065; C25B 11/081; C25B 13/07; C25B 13/08; H01M 4/923; H01M 4/926; H01M 8/1023; H01M 8/1039; H01M 8/1051; H01M 8/1055; H01M 2008/1095; H01M 2300/0082; H01M 2300/0094

(57) ABSTRACT

A membrane electrode assembly with an anode, a cathode and a hydrocarbon membrane lying between the anode and the cathode. The membrane electrode assembly further includes a protective layer, which is arranged between the anode and the hydrocarbon membrane and/or between the cathode and the hydrocarbon membrane, wherein the protective layer includes at least one ceramic material and one fluorine-containing ionomer, wherein the ceramic material is dispersed in the fluorine-containing ionomer.

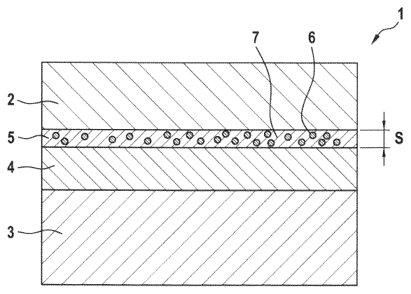

### CROSS REFERENCE TO RELATED APPLICATIONS

This application is a US national stage filing under 35 U.S.C. § 371 of International Application No. PCT/EP2024/058104, filed Mar. 26, 2024, which claims priority to German Patent Application No. 102023107646.9, filed Mar. 27, 2023, each of which is incorporated herein by reference in its entirety.

### TECHNICAL FIELD

This disclosure relates to a membrane electrode assembly, which may particularly be used for a proton-exchange membrane fuel cell and a proton-exchange membrane water electrolysis cell, as well as a fuel cell and an electrolysis cell with this membrane electrode assembly. In addition, this disclosure also relates to a method for the production of the membrane electrode assembly.

### BACKGROUND

Normally, a fuel cell is operated by delivering hydrogen to the anode and oxygen (air) to the cathode, wherein the cell produces water and current (and a certain amount of heat). On the cathode side of a catalyst coated membrane (CCM) oxygen is reduced to generate water, while on the anode side hydrogen is oxidized to protons, which through the membrane travel to the cathode side for reacting with oxygen according to the following reaction equations:

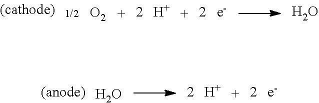

In water electrolysis, the reaction is conversely, i.e., water and current are delivered to the cell for generating hydrogen and oxygen according to the following reaction equations:

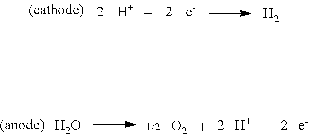

The most common catalysts for each electrode and use are for a fuel cell cathode oxygen reduction reaction (Engl. oxygen reduction reaction, ORR) catalysts such as platinum or platinum alloys, carried on carbon, for a fuel cell anode hydrogen oxidation reaction (Engl. hydrogen oxidation reaction, HOR) catalysts such as platinum, carried on carbon (Pt/C), for a water electrolysis cathode hydrogen evolution reaction (Engl. hydrogen evolution reaction, HER) catalysts such as platinum, carried on carbon, and for a water electrolysis anode oxygen evolution reaction (Engl. oxygen evolution reaction, OER) catalysts such as iridium oxide or mixed iridium-ruthenium oxide, not carried or carried on another non-noble metal oxide.

The above-mentioned catalyst metal types and carriers are selected under consideration of the best electrocatalytic activity and sufficient stability. The best electrocatalytic activity means an overvoltage which is as low as possible, so that the reaction can proceed with adequate velocity. Sufficient stability means a neglectable corrosion or dissolution in the cell environment over the service life required for the use.

In water electrolysis cells, the hydrogen evolution on platinum is a simple reaction and occurs at very low overvoltages, which means that the cathode voltage of the water electrolysis cells during normal operation remains close to zero (against RHE—reversible hydrogen electrode). At this low potential, carbon is stable and can be used as catalyst carrier.

The oxygen evolution on the anode occurs at potentials of above the thermodynamic potential for the water splitting, which is 1.23 V against RHE. Typical anode potentials due to reaction overvoltages are much higher than this value, normally between 1.5 V and 2.0 V. In this voltage range carbons are not stable and are oxidized during a longer time, therefore, they are not used on the anode side neither as catalyst carrier nor in other parts of the cell on the anode side (e.g., transport layers or cell plates).

In a fuel cell, the oxygen reduction as a result of reaction overvoltages occurs at voltages of below the thermodynamic potential of the reaction between hydrogen and oxygen to water, i.e., in contrast to water electrolysis, below 1.23 V against RHE. Therefore, typical cathode potentials are between 0.6 V and 1.0 V. At these potentials, carbon carriers are stable and can be used for increasing the catalyst activity.

When on the anode side a suitable catalyst is used, such as, e.g., a catalyst on the basis of platinum which is dispersed on a carbon carrier with large surface, then the hydrogen oxidation is very efficient and easily proceeds at very low overvoltages, which means that the anode voltage remains very close to zero against RHE. This applies to normal operation.

However, in a fuel cell stack, occasionally it may happen, e.g., during starting up, under cold and wet conditions or in the instance of fast transitions, that one or more cells at the anode suffer from a lack of hydrogen. This means that not enough hydrogen is delivered to the anode for maintaining the stack current and for providing sufficient electrons. This situation results in the affected cells in reverse voltage.

Under such a cell reversal (Engl. cell reversal, CR) condition, the anode voltage increases to values which may be far above the cathode voltage, e.g., above 1.5 V against RHE, and the anode side of the cell may corrode and fail quickly. By the corrosion, i.e., the oxidation of the carbon, the deficiency of electrons mentioned previously is compensated. The anode component which normally is most subjected to corrosion is the carbon carrier of the catalyst.

Furthermore, increased potentials of up to higher than 1.5 V against RHE on the cathode side occur particularly under start-up/shut-down operating conditions (in the following: SUSD, Engl.: start-up/shut-down). During the start-up of the fuel cell the anode is filled with air, thus also with oxygen, so that during letting hydrogen into the anode a so-called hydrogen/air-front is generated. At this hydrogen/air-front, besides the oxidation of hydrogen, on the anode a reduction of oxygen occurs, which goes along with an oxidation reaction on the cathode side. The cathode component which normally is most subjected to oxidation and corrosion, respectively, is the carbon carrier of the catalyst.

The carbon carrier, both on the anode and the cathode side, is oxidized according to the following reaction:

(Anode of a Fuel Cell Under Cell Reversal and/or Cathode Under SUSD)

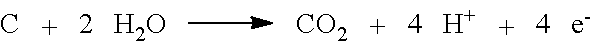

A failure of the fuel cell occurs, when the carbon corrosion has proceeded in such an extent that the performance of the CCM under a normal state of the hydrogen feed is considerably compromised. In default of a suitable mitigation strategy, a failure of the anode under cell reversal can very quickly occur, typically within several tens of seconds up to very few minutes.

For protecting the carbon of the anode and/or cathode electrode under cell reversal and/or SUSD conditions from corrosion, a well-established technical solution is the addition of a catalyst for the oxygen evolution reaction (OER) to the electrode, which normally is present homogenously mixed with the hydrogen oxidation catalyst (anode) and the oxygen reduction catalyst (cathode), respectively. The presence of such catalysts, typically on the basis of iridium oxide, allows the oxidation of water at the electrode with higher rates than the carbon corrosion, so that the water oxidation in comparison to the oxidation of carbon is preferred, according to the following reaction:

2H₂O→O₂+4H⁺+4e⁻ (anode under cell reversal and/or cathode under SUSD)

In this manner, the behavior of the cell under cell reversal is that of an electrolysis cell, in which at the cathode air (oxygen) is reduced and at the anode water is oxidized to oxygen.

Therefore, the cell current is maintained, rather by the oxidation of water than by the corrosion of carbon, so that the anode can longer survive the condition of the cell reversal and the cathode can longer survive the starting up and shutting down. The water oxidation reaction limits the increase of the anode potential to values of 1.6 to 2 V against RHE and, therefore, limits the carbon corrosion rate, which means that carbon corrosion still occurs, but with much lower rates, in comparison to the situation, when the voltage is not controlled by the presence of the OER catalyst. When such a protection strategy is used, then the CCM can survive a condition of cell reversal for a period of time of several tens of minutes and even up to many tens of hours.

The above description shows that normally water electrolysis cell anodes work under high potentials of 1.5 V to 2.0 V, but also fuel cell anodes due to hydrogen deficiency over longer period of times (cumulated) may be subjected to similarly high potential values.

Furthermore, membranes are well-known, which are used in fuel cells and water electrolysis cells, which are based on hydrocarbon, so-called hydrocarbon membranes. Thus, the structure of the ionomer (i.e., the proton-conducting polymer) which is contained in the membrane does not contain fluorine, or only in limited amounts of at most 5% by mass, based on the mass of the ionomer used.

In comparison to perfluoro sulfonic acid membranes (PFSA membranes), hydrocarbon membranes are characterized by several advantages. For example, they have a lower gas permeability through the membrane, so that higher cell current yields can be achieved, even when very thin membranes are used, which result in a very low ion resistance (and thus a very good performance). In addition, they can be operated for a longer time at high temperatures >100° C. with limited degradation, which is the result of the low gas permeability (also at high temperature) and the high glass transition temperature being typical for hydrocarbon-based polymers. An operation at higher temperature results in several advantages of the system: reduced size of the cooling facility, lower susceptibility with respect to gas impurities and higher degree of efficiency of the cell. Hydrocarbon membranes also emit lower amounts of aggressive degradation products, e.g., HF and extremely acidic sulfonic acid molecules which are released from PFSAs, which results in a lower damaging of the metallic bipolar plates in the stack during the operation, which in turn allows a longer service life and/or the use of cheaper materials. Finally, hydrocarbon membranes in comparison to perfluorinated ionomers have an improved environmental profile, because they do not contain perfluoroalkyl compounds, and during their production no perfluoroalkyl chemistry is required.

On the other hand, we have found that hydrocarbon membranes at the high potentials which normally are used in water electrolysis anodes or which occur in fuel cell anodes under cell reversal conditions as well as fuel cell cathodes under SUSD, i.e., at voltages >1.5 V, have an insufficient electrochemical stability. Under these high potentials hydrocarbon membranes tend to be oxidized and damaged leading to an impairment of the performance and a CCM failure.

Therefore, there is a need to improve the stability of CCMs (generally membrane electrode assemblies—MEA) which contain hydrocarbon membranes for use conditions, which comprise a prolonged exposure of the anode and/or the cathode to high potentials, either continuously or intermittently.

It could therefore be helpful to provide an MEA which comprises a hydrocarbon membrane and is better protected from corrosion and thus oxidation, and as a result of this has a longer service life. Further, it could also be helpful to provide a fuel cell and a water electrolysis cell, respectively, which are characterized due to the use of the membrane electrode assembly by an increased service life due to reduced tendency to corrosion and tendency to oxidation. Furthermore, it could also be helpful to provide a method for the production of a membrane electrode assembly with reduced corrosion tendency and reduced oxidation tendency.

### SUMMARY

We thus provide a membrane electrode assembly which includes an anode, a cathode and a hydrocarbon membrane arranged between the anode and the cathode, further including a protective layer, which is arranged between the anode and the hydrocarbon membrane and/or between the cathode and the hydrocarbon membrane, wherein the protective layer includes at least one ceramic material and a fluorine-containing fluorine-containing ionomer, wherein the ceramic material is distributed in the fluorine-containing fluorine-containing ionomer.

### BRIEF DESCRIPTION OF THE DRAWING

The FIGURE is an MEA according to a first embodiment in sectional view.

### LIST OF REFERENCE SIGNS

1 membrane electrode assembly
2 anode
3 cathode
4 hydrocarbon membrane
5 protective layer
6 ceramic material
7 fluorinated ionomer
S layer thickness of the protective layer

### DETAILED DESCRIPTION

Our method is solved by a membrane electrode assembly (MEA) which comprises an anode, a cathode and a hydrocarbon membrane lying between the anode and the cathode and further a protective layer, which is arranged between the anode and the hydrocarbon membrane and/or the cathode and the hydrocarbon membrane.

The hydrocarbon membrane comprises at least one ionomer which is not fluorinated, or the content of fluorine of which is at most 5% by mass, based on the total mass of the ionomer.

The protective layer comprises at least one ceramic material and a fluorine-containing ionomer, wherein the ceramic material is distributed, thus dispersed in the fluorine-containing ionomer. In other words, the protective layer may comprise one single ceramic material or a mixture of ceramic materials. The same is also true for the fluorine-containing ionomer. In other words, the protective layer may comprise one single fluorine-containing ionomer or a mixture of two or more fluorine-containing ionomers. The fluorine-containing ionomer may be partially fluorinated or perfluorinated, or mixtures of partially fluorinated and/or perfluorinated ionomers can be used. Fluorinated ionomers are well-known for a person skilled in the art, e.g., under the trade names Nafion® (The Chemours Company), Forblue i-series (AGC Inc.) or Aquivion® (Solvay). The structure of the side chains may comprise a different number of CF₂ groups or also branched structures, and it is not limited in detail.

The ceramic material is not limited in detail, and advantageously it is characterized by electrically non-conductive properties, and it is present dispersed, thus distributed in the ionomer(s) containing fluorine. This may, e.g., be achieved by the fact that in the production of the protective layer a protective layer dispersion is prepared in which the ceramic material and the fluorine-containing ionomer are sufficiently mixed before further processing to the protective layer is conducted. With electrically non-conductive properties materials with a specific conductivity of lower than 10⁻³ S/m are meant. The conductivity is measured with powders at a compression of 50 MPa.

We found that the use of the protective layer which at least comprises one ceramic material and at least one fluorine-containing ionomer between the hydrocarbon membrane and the anode and/or the cathode protects the MEA, and here particularly the hydrocarbon membrane, from oxidation and thus also from corrosion, so that the MEA, even when persistently high potentials on the anode side or the cathode side is not degraded. As a result, the MEA which contains the hydrocarbon membrane with a protective layer does not lose its performance capability.

The oxidation of a hydrocarbon membrane in an MEAA which is subjected to high anode or cathode potentials of higher than 1.5 V and which does not contain a protective layer can be detected by the presence of a strong CO₂ signal at the anode or cathode outlet of a cell. We have found that this signal in the presence of the protective layer is suppressed, which shows that the hydrocarbon membrane substantially does not suffer from oxidation. This is a proof for the effectivity of the approach of the this disclosure for the solution of the above problem.

Without being bound to a theory, it is assumed that the hydrocarbon membrane in the MEA does not suffer from any oxidation, because the protective layer reduces the potential at the membrane surface to values which are lower than the anode or cathode potential. For maximizing this effect, preferably, the ceramic material is electrically non-conductive. In addition, it is assumed that the avoidance of the contact between the membrane surface and the electrode catalyst material further protects the hydrocarbon membrane from oxidative degradation. The protective layer is very stable, due to the stable materials of which it consists, therefore it is not degraded neither by the high potentials nor by a contact with a catalyst of the electrode layers, and thus it protects also the hydrocarbon membrane from oxidation.

According to an advantageous further development, the protective layer is free of catalysts containing metal, because the corrosion protection effect is supported best.

The hydrocarbon ionomers and resultant hydrocarbon membranes, respectively, are not limited in detail.

Hydrocarbon ionomers and resultant hydrocarbon membranes, respectively, are preferably of the sulfonated type. Sulfonated hydrocarbon ionomers are typically classified as sulfonated polystyrene copolymers (SPS), sulfonated polyimides (SPI), sulfonated polyphenylenes (SPP), polymers of the type sulfonated polyarylene, or polyphosphazenes (SPPh). Belonging to these classes, the following exemplary hydrocarbon ionomer types can be mentioned:

Sulfonated polyaryl ethers (SPAE), sulfonated polyaryl ether ether nitriles (SPAEEN), sulfonated polyaryl ether ketones (SPAEK), sulfonated polyaryl ether nitriles (SPAEN), sulfonated polyaryl ether sulfones (SPAES), sulfonated polyaryl ether sulfone ketones (SPAESK), sulfonated polyether ether ketones (SPEEK), sulfonated polyether ketones (SPEK), sulfonated polyether sulfones (SPES), sulfonated polyimides (SPI), sulfonated polyketone ketones (SPKK), sulfonated polyphosphazenes (SPPh), sulfonated polyphenylene sulfones (SPPSf), sulfonated polyphenylene sulfide sulfones (SPPSSf), sulfonated polyphenylene sulfide sulfone nitriles (SPPSSfN), sulfonated polystyrenes (SPS), sulfonated polysulfones (SPSf), sulfonated polyphenylenes (sPP), sulfonated phenylated polyphenylenes (sPPP).

Particularly stable hydrocarbon membranes are selected from sulfonated polyether ketones, sulfonated polyether ether ketones, sulfonated polyketone ketones, sulfonated polyphenylenes, sulfonated phenylated polyphenylenes and mixtures thereof.

Hydrocarbon ionomers may be linear polymers, cross-linked polymers, branched polymers, grafted polymers, and/or block polymers. Optionally, they may also contain hetero atoms such as F, N, S, and P. Block copolymers containing sulfonic acid-rich blocks alternately with sulfonic acid-poor or non-sulfonated blocks are particularly advantageous with respect to the combination of high proton conductivity, good mechanical properties and high dimensional stability.

In addition, we found that the presence of the ceramic material in the protective layer, in addition to the provision of a high oxidation stability for the MEA, can also guarantee a very good adhesiveness between the protective layer and the hydrocarbon membrane, so that the hydrocarbon membrane, even under dynamic conditions of relative humidity (alternately wet and dry) or conditions at which the cell is operated in a wet and warm state, such as in water electrolysis cells, and thus also the whole MEA, maintains its integrity. For achieving such a good adhesiveness, preferably, the total volume of the ceramic material in the protective layer, based on the total volume of the protective layer, is at least 17% by volume and particularly at least 25% by volume and particularly at least 30% by volume. The total volume of the protective layer is defined as the sum of the volumes of the single components. The lower the total volume of the ceramic material, the higher the tendency of the protective layer to peeling off of the hydrocarbon membrane due to the low compatibility between the (per)fluorinated ionomer and the hydrocarbon ionomer of the hydrocarbon membrane, and the MEA loses performance.

For, in the instance of good adhesiveness, providing a very good proton conductivity which is achieved by a sufficiently high portion of fluorinated ionomer, it is advantageous, when the total volume of ceramic material in the protective layer is not too high. It is also possible that by a particularly high portion of ceramic material the protective layer becomes brittle and mechanically instable. Therefore, preferably, the total volume of the ceramic material in the protective layer, based on the total volume of the protective layer, is lower than 76% by volume and particularly lower than 65% by volume and particularly lower than 54% by volume.

Particularly suitable volume ranges of ceramic material are 17 to 76% by volume, 25 to 65% by volume and particularly 30 to 54% by volume.

The optimum volume portion of the ceramic material in the protective layer can, with regard to the above requirements, be determined by optimization by starting with low values of the amount of ceramic material and increasing these values by, e.g., steps of 5% by volume, until the minimum amount c_{C_min} which results in good adhesiveness is found. Then, the amount of ceramic material can further be increased up to a point c_{C_max} at which the MEA ion resistance owing to the protective layer starts measurably to increase, e.g., by more than 5% above the value at which initially a good adhesiveness has been determined. The optimum amount of ceramic material c_{C_opt} is then between both values c_{C_min} and c_{C_max}. Generally, the optimum volume portion of ceramic material may depend on factors such as the chemical nature of the ceramic material, its specific surface area (e.g., determined by BET, thus by nitrogen adsorption according to DIN ISO 9277:2003-05 “Bestimmung der spezifischen Oberflache von Feststoffen durch Gasadsorption nach dem BET-Verfahren”), the method used for mixing of the ceramic material with the fluorinated ionomer, etc.

The good adhesiveness between the hydrocarbon membrane and the protective layer and, generally, between the different layers of the MEA can be determined by immersing the MEA into boiling water for a longer period of time, e.g., 4 hours, and the visual observation of the MEA. When the adhesiveness is good, then the MEA maintains its integrity, i.e., the different layers do not separate from each other, and also other small parts do not separate from the MEA.

According to an advantageous further development, a specific surface area of the ceramic material, measured according to BET (according to DIN ISO 9277:2003-05 “Bestimmung der spezifischen Oberflache von Feststoffen durch Gasadsorption nach dem BET-Verfahren”), is 5 to 800 m²/g and particularly 20 to 500 m²/g. Ceramic materials with a specific surface area in the mentioned range can very well be dispersed in fluorinated ionomers.

Advantageously, the ceramic material is a ceramic material which at low potentials is stable in hydrogen. In other words, the ceramic material in the protective layer is preferably at low potentials (close to zero) in the presence of hydrogen stable against reduction. In fact, the anode side, particularly in a fuel cell use, for the most time (normal operation) will be subjected to low potentials in a hydrogen environment. But also, in a water electrolysis cell it may happen that the anode in the instance of shut-down events is subjected to low potentials, wherein hydrogen from the cathode side passes over to the anode side. When therefore the ceramic material at low potentials against hydrogen is not stable, then the metal is reduced and dissolved step by step, and the function of the protective layer is lost with time. In the instance of water electrolysis cell uses this requirement is less strong, because the anode is not so often subjected to low potentials; in addition, it is possible to develop shut-down strategies which generally prevent the presence of such a condition at the anode (e.g., the draining of very low currents from the stack). In the light of a very good reduction stability, therefore, it is advantageous, when the ceramic material has a weight loss of less than 2% by mass, when the ceramic material is subjected to a stream of hydrogen of 3.3% by volume in argon for 12 hours at a temperature of 80° C.

Further advantageously, the ceramic material is selected from at least one of oxides, nitrides, carbides, silicides, borides and mixtures thereof. The oxides, nitrides, carbides, silicides, and borides are not limited in detail. Advantageously, however, they are oxides, nitrides, carbides, silicides, and borides of at least one of the following metals: silicon, tantalum, niobium, tin, titanium, zirconium, cerium, tungsten, antimony or mixtures thereof. Due to the very good reduction stability, the ceramic material is particularly selected from Nb₂O₅, Ta₂O₅, SiO₂, WO₃, ZrO₂ and mixtures thereof.

Further advantageously, in the light of a minimum additional proton resistance by the MEA, the equivalent weight of the proton-conductive polymer of the protective layer may be less than 1050 g/mol, preferably less than 950 g/mol and further preferably less than 850 g/mol. The equivalent weight is the weight of the ionomer per mol of functional groups, particularly sulfonic acid groups.

Further advantageously, the layer thickness of the protective layer, in the light of a minimum additional proton resistance by the MEA, can be adjusted and/or selected. The lower limit of the layer thickness is not particularly limited, whilst a layer with controlled layer thickness without imperfections is prepared. Preferably, the protective layer has a layer thickness of higher than or equal to 0.1 μm, further preferably of higher than or equal to 0.15 μm, still further preferably of higher than or equal to 0.2 μm. It is essential that the layer is a continuous layer, in other words, a closed layer, i.e., so that it does not comprise cracks or defects. The layer thickness may be determined by scanning electron microscopy.

In view of an easy and light building technique of the MEA and a minimum additional proton resistance, it is further advantageous, when the layer thickness of the protective layer is not too high and thus particularly is lower than 10 μm, particularly lower than 5 μm and particularly lower than 3 μm.

It is particularly advantageous, when the layer thickness of the protective layer is 0.1 to 10 μm, particularly of 0.2 to 5 μm and particularly in a range of 0.5 to 3 μm.

The cathode comprises at least one catalyst catalyzing the cathode reaction. Advantageously, the cathode comprises at least one catalyst containing platinum, wherein a load of the cathode with catalyst, expressed in platinum weight per unit area of the cathode, is particularly 0.02 to 1 mg Pt/cm², particularly 0.05 to 0.6 mg Pt/cm² and particularly 0.1 to 0.4 mg Pt/cm². The catalyst containing platinum may be platinum or a platinum alloy.

For improving the efficiency of the cathode reaction, it is particularly advantageous, when the catalyst containing platinum of the cathode is carried, wherein the carrier of the catalyst containing platinum preferably comprises carbon.

In water electrolysis, for guaranteeing the efficiency of the MEA, or in the fuel cell, for improving the permanent stability, the anode comprises at least one oxygen evolution catalyst (OER catalyst).

Due to the very good catalytic activity and the stability against dissolution during operation, the OER catalyst comprises particularly iridium oxide or a mixed iridium-ruthenium oxide. In an alternative or in addition, the OER catalyst may be carried, particularly on a base metal oxide, which preferably is a titanium oxide or a niobium oxide. Base metals are metals with a standard potential vs. RHE of lower than 0.7 V.

A further advantageous further development, in the light of the increase of the efficiency of the MEA, is that the anode further comprises a hydrogen oxidation reaction catalyst (HOR catalyst), particularly an HOR catalyst containing platinum, wherein the load of the anode with HOR catalyst containing platinum, expressed in platinum weight per unit area of the anode, is particularly 0.01 to 0.2 mg Pt/cm² and particularly 0.03 to 0.1 mg Pt/cm². It is particularly advantageous when the HOR catalyst is carried on a carrier containing carbon.

The membrane electrode assembly is advantageously formed either as fuel cell membrane electrode assembly or as water electrolysis cell membrane electrode assembly.

When the MEA is formed as water electrolysis cell membrane electrode assembly, then a load of the anode with catalyst, expressed in iridium weight per unit area of the anode, is advantageously 0.05 to 2 mg Ir/cm², particularly 0.1 to 1.5 mg Ir/cm² and particularly 0.2 to 1 mg Ir/cm².

When the MEA is formed as fuel cell membrane electrode assembly, then a load of the anode with catalyst, expressed in iridium weight per unit area of the anode, is advantageously 0.005 to 0.05 mg Ir/cm², particularly 0.006 to 0.03 mg Ir/cm².

When the MEA is formed as water electrolysis cell membrane electrode assembly, then the layer thickness of the hydrocarbon membrane is preferably 150 μm or less.

The hydrocarbon membrane may comprise a mechanical reinforcement, for example, in the form of fibers or reinforcing structures. A reinforcing structure can, for example, be implemented during the production process of the hydrocarbon membrane from an ionomer dispersion or ionomer solution. Thus, a previously formed reinforcing structure, such as ceramic materials or polymeric materials, such as, e.g., (bi)axially stretched PTFE (ePTFE, Engl.: expanded PTFE), or woven structures, such as, e.g., woven fabric made of polyketone (PK) fibers, polyether ketone (PEK) fibers, polyether ether ketone (PEEK) fibers, perfluoroalkoxy alkane (PFA) fibers, or polyphenylene sulfide (PPS) fibers, is impregnated with a corresponding ionomer dispersion and subsequently dried, so that the pores of the reinforcing structure are filled with ionomer. In this instance, in which the hydrocarbon membrane comprises a mechanical reinforcement, the layer thickness of the hydrocarbon membrane is advantageously 20 to 120 μm, particularly 30 to 100 μm.

When the MEA is formed as fuel cell membrane electrode assembly, then the layer thickness of the hydrocarbon membrane is preferably 20 μm or less.

The hydrocarbon membrane may comprise a mechanical reinforcement, for example, in the form of fibers or reinforcing structures. A reinforcing structure can, for example, be implemented during the production process of the hydrocarbon membrane from an ionomer dispersion or ionomer solution. In this instance, a previously formed reinforcing structure, such as ceramic materials or polymeric materials, such as, e.g., (bi)axially stretched PTFE (ePTFE, Engl.: expanded PTFE), or woven structures, such as, e.g., woven fabric made of polyketone (PK) fibers, polyether ketone (PEK) fibers, polyether ether ketone (PEEK) fibers, perfluoroalkoxy alkane (PFA) fibers, or polyphenylene sulfide (PPS) fibers, is impregnated with a corresponding ionomer dispersion and subsequently dried, so that the pores of the reinforcing structure are filled with ionomer. In this instance, in which the hydrocarbon membrane of the fuel cell membrane electrode assembly comprises a mechanical reinforcement, the layer thickness of the hydrocarbon membrane is advantageously 5 to 15 μm.

When required, between the protective layer and the anode or between the protective layer and the cathode further additional layers can be included.

Furthermore, a water electrolysis cell and a fuel cell, which comprise the membrane electrode assembly are described. By using the membrane electrode assembly the service life of the water electrolysis cell and the fuel cell is improved, because the corrosion and oxidation of the MEA are reduced. The water electrolysis cell and the fuel cell, respectively, are particularly a PEM water electrolysis cell or a PEM fuel cell.

The advantageous further developments of the membrane electrode assembly also apply to the fuel cell and the water electrolysis cell.

Furthermore, a first method for the production of a membrane electrode assembly such as disclosed above is described. Our method comprises at first a step of preparing a protective layer dispersion, which comprises at least one ceramic material and at least one fluorine-containing ionomer, such as described above for the MEA. The ceramic material and the ionomer are dispersed or suspended in a liquid medium, for example, in a polar organic solvent or a mixture of polar organic solvents or water or preferably in a mixture of water and one or more polar organic solvents. Non-limiting examples for polar organic solvents are acetone, acetonitrile, dimethyl formamide (DMF), dimethyl sulfoxide (DMSO), N-methyl-2-pyrrolidone (NMP), 1-propanol, 2-propanol, ethanol, 1-butanol, or tert-butyl alcohol.

For the preparation of the protective layer dispersion, the ceramic material and the fluorine-containing ionomer can be ground together in a ball mill (grinding medium: ZrO₂ balls). The grinding time may, e.g., be 120 minutes, but it depends on the dispersibility of the ceramic material, and it can be adapted accordingly.

In an alternative or in addition, for the production of a dispersion, ultrasonics or different grinding body mills can be used. Grinding body mills are, e.g., ball mills, agitator bead mills, agitator mills, attritors, and specific rolling mills.

In the following description, the term electrode, in the fuel cell, comprises both the anode and also the cathode, in the water electrolysis particularly only the anode, because on these electrodes high potentials of >1.5 V may occur, and the protective layer may show an advantageous effect.

In a further method step, the protective layer dispersion is applied onto an electrode or a hydrocarbon membrane. As application methods, particularly, common technologies such as, e.g., slit dies, doctor blades, spiral applicators, screen printing or also spraying facilities are used.

Subsequently, the protective layer dispersion is dried, wherein the protective layer on the electrode or the hydrocarbon membrane is obtained.

When the protective layer dispersion is applied onto the electrode, then in a further method step, a lamination of the electrode provided with the protective layer and the hydrocarbon membrane may be conducted. Particularly, the lamination temperature is 150 to 190° C., and the pressure is 1 to 3 MPa. The lamination time may be about one minute.

The above procedural method is also used when the protective layer dispersion has been applied onto the hydrocarbon membrane. Then, a lamination with the electrode is conducted.

This first method using common technologies can easily be implemented and allows the production of an MEA with high oxidation and corrosion stability.

According to a second method, the production of the MEA, at first, comprises again the preparation of a protective layer dispersion, which can be conducted such as explained for the first method. The protective layer dispersion again comprises at least one ceramic material and at least one fluorine-containing ionomer.

Subsequently, the protective layer dispersion is applied onto a substrate. The substrate with respect to the protective layer dispersion is inert, thus, do not show chemical or physical reactivity in connection with the protective layer dispersion.

In a further method step, the protective layer dispersion is dried, wherein the protective layer is prepared and, thus, a so-called decal is obtained.

Then, the protective layer is transferred onto the electrode or onto the hydrocarbon membrane, and subsequently the substrate is removed.

Depending on whether the protective layer has been transferred onto the electrode or onto the hydrocarbon membrane by the decal method, furthermore a lamination with either a hydrocarbon membrane or an electrode may be conducted, such as described above for the first method.

Also, this second method can easily be implemented using common technologies and allows the production of an MEA with high oxidation and corrosion stability.

According to a third method, at first, again, such as already described above, a protective layer dispersion is prepared, which comprises at least one ceramic material and at least one fluorine-containing ionomer.

Furthermore, an electrode dispersion is prepared. The electrode dispersion comprises particularly at least one catalytically active substance, such as explained for the MEA.

Then, a further decal method is conducted, by first applying the electrode dispersion and then the protective layer dispersion onto the electrode dispersion which has been applied onto the substrate. Thus, a layer assembly is formed: substrate/electrode dispersion/protective layer dispersion.

The dispersions are dried. It is not necessary to follow a particular order. E.g., at first, the electrode dispersion can be dried or partially dried, before the protective layer dispersion is applied, or the protective layer dispersion is applied onto the electrode dispersion which is still not dried or not completely dried, and both dispersions are dried at the same time, wherein the electrode layer and the protective layer on the substrate are prepared.

Then, the decal, thus the dried electrode layer/protective layer-assembly is transferred onto the hydrocarbon membrane, so that the protective layer is arranged between hydrocarbon membrane and electrode.

By the third method, the production of an MEA with high oxidation and corrosion stability using common technologies is possible easily.

Subsequently to the above method steps of the third method, a step of laminating the electrode layer/protective layer-assembly and the hydrocarbon membrane may be conducted, such as already described for the first and second methods.

According to a fourth method, at first, again, such as already described above, a protective layer dispersion is prepared, which comprises at least one ceramic material and at least one fluorine-containing ionomer.

Furthermore, an electrode dispersion (anode dispersion and cathode dispersion, respectively) is prepared. The electrode dispersion particularly comprises at least one catalytically active substance, such as described for the MEA according to the present invention.

Then, the protective layer dispersion is applied onto the hydrocarbon membrane, and subsequently the electrode dispersion is applied onto the protective layer dispersion.

Furthermore, a drying of the dispersions is conducted, wherein the electrode layer and the protective layer are prepared, wherein the dispersions can be dried one after the other or together.

Also, the fourth method results in an MEA with improved oxidation and corrosion stability, wherein the method can easily be implemented with common technologies.

When the MEA, which is prepared as a fuel cell membrane electrode assembly, then, also, the following fifth method can be conducted:

In a first step, such as already described for all above methods, the preparation of a protective layer dispersion, which comprises at least one ceramic material and at least one fluorine-containing ionomer is conducted. Also, the preparation of an electrode dispersion is conducted.

Then, the electrode dispersion (anode dispersion and cathode dispersion, respectively) is applied onto a gas diffusion layer, and subsequently the protective layer dispersion is applied onto the electrode dispersion.

Furthermore, a drying of the dispersions is conducted, wherein the electrode layer and the protective layer are prepared, wherein the dispersions can be dried one after the other or together.

Then, the protective layer/electrode layer/gas diffusion layer-assembly is arranged on a hydrocarbon membrane, and a step of lamination, such as disclosed for the above methods, can follow.

In an alternative method step of the fifth method, the protective layer dispersion is applied onto the hydrocarbon membrane. In a further method step the protective layer dispersion is dried, wherein the protective layer is produced. Then, the electrode layer/gas diffusion layer-assembly is arranged on a protective layer/hydrocarbon membrane-assembly, and a step of lamination, such as disclosed for the above methods, can follow.

Also, the fifth method results in an MEA with improved oxidation and corrosion stability, wherein the method can easily be implemented with common technologies.

Subsequently, after all above disclosed methods a further method step of tempering in a temperature range of 150 to 200° C. can follow, for strengthening the mechanical properties of the protective layer. This step optionally may coincide with one of the decal methods.

In all above methods, the respective counter electrode can be provided by a decal method, by direct coating or as gas diffusion electrode. The respective methods for the anode and cathode sides can be combined independently from each other.

The production of the MEA according to the methods can easily be realized with high production rates with techniques and equipment according to prior state, which are already used in the production of fuel cell membrane electrode assemblies and water electrolysis cell membrane electrode assemblies.

Further details, advantages and features arise from the following description of embodiment examples with the help of the drawing.

In the FIGURE, only the essential components of the MEA are shown. For the sake of clarity, all other components are omitted.

The FIGURE shows in detail an MEA 1 which can be used for a fuel cell or an electrolysis cell.

The MEA 1 is shown in sectional view and comprises an anode 2, a cathode 3 and a hydrocarbon membrane 4 lying between the anode 2 and the cathode 3. Between the hydrocarbon membrane 4 and the anode 2 a protective layer 5 is present, which protects the MEA 1 from corrosion and oxidation processes.

This protection mechanism can be seen, e.g., when the MEA is used in a fuel cell, when this cell is operated under cold and wet conditions or when quick transitions occur, when the cells of the fuel cell at the anode suffer from a deficiency of hydrogen, so that not sufficient hydrogen is delivered to the anode for maintaining the stack current and providing sufficient electrons, which results in a voltage reversal of the affected cells. Under such a cell reversal condition the anode voltage increases to values which may be much higher than the cathode voltage (e.g., >1.5 V against RHE). As a result of this, the anode side of the fuel cells may quickly corrode and fail, which is prevented by the MEA.

The above advantageous effects are also shown, when the MEA is used in a water electrolysis cell. The oxygen evolution occurs at the anode at potentials of higher than the thermodynamic potential for the water splitting, which is 1.23 V against RHE. Typical anode potentials due to reaction overvoltages are much higher than this value, normally between 1.5 V and 2.0 V. In this voltage range carbons are not stable and are oxidized over a longer period of time. These oxidation processes are also prevented by the MWA.

These unexpected advantageous effects can be ascribed to the structure of the MEA 1, such as is shown in the FIGURE. Between the hydrocarbon membrane 2 and the anode 3 the protective layer 5 is present, which comprises at least one ceramic material 6 and at least one fluorine-containing ionomer 7, wherein the ceramic material 6 is distributed in the fluorine-containing ionomer 7. The total volume of ceramic material 6 is particularly in a range of 17 to 76% by volume, based on the total volume of the protective layer 5.

The ceramic material 6 is advantageously selected from oxides, nitrides, carbides, silicides, borides and mixtures thereof, of at least one, selected from silicon, tantalum, niobium, tin, titanium, zirconium, cerium, tungsten, antimony or mixtures thereof. In addition, the ceramic material 6 is particularly stable against reduction by hydrogen. For this, it is advantageously selected from Nb₂O₅, Ta₂O₅, SiO₂, WO₃, ZrO₂ and mixtures thereof.

The equivalent weight of the proton-conductive polymer (7) of the protective layer is smaller than 1050 g/mol and particularly smaller than 950 g/mol and particularly smaller than 850 g/mol, so that also a limited amount of ionomer a sufficient number of proton-conductive sulfonic acid groups is present, and thus the protective layer in total has a high proton conductivity.

A layer thickness S of the protective layer 5 is particularly 0.1 to 10 μm, so that the protective effect is particularly efficiently achieved with an own volume and own weight being as low as possible.

The hydrocarbon membrane 4 particularly comprises sulfonated polyether ketones, sulfonated polyether ether ketones, sulfonated polyketone ketones, sulfonated polyphenylenes, sulfonated phenylated polyphenylenes and mixtures thereof.

The cathode 3 comprises at least one catalyst containing platinum, wherein a load of the cathode 3 with catalyst, expressed in platinum weight per unit area of the cathode 3, is particularly between 0.02 and 1 mg Pt/cm², and the catalyst is particularly carried on a carrier containing carbon.

The anode 2 comprises also at least one catalyst which comprises iridium oxide or a mixed iridium-ruthenium oxide, which optionally is carried on a base metal oxide such as particularly titanium oxide or niobium oxide.

Furthermore, the anode 2 can advantageously comprise a hydrogen oxidation reaction catalyst, particularly a hydrogen oxidation reaction catalyst containing platinum, wherein the load of the anode 2 with hydrogen oxidation catalyst containing platinum, expressed in platin weight per unit area of the anode 2, is particularly 0.01 to 0.2 mg Pt/cm².

Besides the above written description, for its supplemental disclosure herewith, explicitly, reference is made to the graphic representation of this disclosure in the FIGURE.

### Preparation of Membrane Electrode Assemblies in the Form of Catalyst Coated Membranes (CCM)

Catalyst coated membranes (CCM) were prepared from anode catalyst layers which contained 50% by mass of Pt on graphitized carbon with a load of platinum of 0.05 mg Pt/cm² and cathode catalyst layers which contained 50% by mass of PtCo on carbon with a load of platinum of 0.50 mg Pt/cm². Then, catalyst coated membranes (CCMs) were prepared by use of a decal method (standard decal transfer method), wherein an ionomer membrane was arranged between an anode layer and on the other side of the membrane opposite cathode layer. The active surface of both catalyst layers was 71 mm×62 mm and the membrane size was 100 mm×100 mm. Table 1 summarizes the CCM compositions.

An anode catalyst ink was prepared by mixing of a Pt/C (50% by mass of Pt on carbon) catalyst as well as an iridium oxide catalyst in water, organic solvents and a D79-25BS PFSA ionomer dispersion from Solvay Specialty Polymers. The platinum/iridium-mass ratio was 1:1. The ionomer/carbon-mass ratio was 0.8:1. The anode catalyst ink was ground for 120 minutes in a ball mill (grinding medium: ZrO₂ balls having a diameter of 1 mm). An anode catalyst layer was prepared by applying the catalyst ink onto a substrate and drying (decal method).

A cathode catalyst ink was prepared by mixing of a PtCo/C (50% by mass of PtCo on carbon) catalyst, water, organic solvents and a D79-25BS PFSA ionomer dispersion from Solvay Specialty Polymers. The ionomer/carbon-mass ratio was 1:1. The cathode catalyst ink was ground for 120 minutes in a ball mill (grinding medium: ZrO₂ balls having a diameter of 1 mm). A cathode catalyst layer was prepared by applying the catalyst ink onto a substrate and drying (decal method).

### Example 1 (Hydrocarbon Membrane with Protective Layer)

For the preparation of a protective layer dispersion 0.83 g of Nb₂O₅(BET surface 6.2 m²/g), 1.40 g of D79-25BS (Solvay, PFSA ionomer dispersion, 25% by mass) and 7.77 g of organic solvents were mixed and ground for 120 minutes in a ball mill (grinding medium: ZrO₂ balls having a diameter of 1 mm). The mass ratio of the metal oxide to ionomer was 2.37:1. This was equivalent to a volume portion of the niobium oxide of 52% by volume. The conversion was conducted via the density of the niobium oxide of 4.6 g/cm³ and the density of the ionomer of 2.1 g/m³. Subsequently, the anode was overlaid with the help of a spiral doctor blade (wire diameter 4 μm) with the protective layer dispersion and dried for 5 minutes at 120° C. in a furnace. The resulting layer thickness of the protective layer measured by scanning electron microscopy was about 200 nm.

Anode and cathode layers were prepared according to the above description. For the production of the CCM, a hydrocarbon membrane of the sPEEK type with a thickness of 7 μm was used. The hydrocarbon membrane was arranged between the protective layer/anode-assembly and the cathode and laminated at a temperature of 160° C. and a pressure of 3 MPA for 1 minute, and subsequently the substrates (decal) were removed.

### Example 2 (Hydrocarbon Membrane with Protective Layer)

For the production of the protective layer, dispersion 0.59 g of Nb₂O₅(BET surface 6.2 m²/g), 2.36 g of D79-25BS (Solvay, PFSA ionomer dispersion, 25% by mass) and 7.05 g of organic solvents were mixed and ground for 120 minutes in a ball mill (grinding medium: ZrO₂ balls having a diameter of 1 mm). The mass ratio of the metal oxide to ionomer was 1:1. This was equivalent to a volume portion of the niobium oxide of 31% by volume. The conversion was conducted via the density of the niobium oxide of 4.6 g/cm³ and the density of the ionomer of 2.1 g/m³. Subsequently, the anode was overlaid with the help of a spiral doctor blade (wire diameter 4 μm) with the protective layer dispersion and dried for 5 minutes at 120° C. in a furnace. The resulting layer thickness of the protective layer measured by scanning electron microscopy was about 200 nm.

Anode and cathode layers were prepared according to the above description. For the production of the CCM, a hydrocarbon membrane of the sPEEK type with a thickness of 7 μm was used. The hydrocarbon membrane was arranged between the protective layer/anode-assembly and the cathode and laminated at a temperature of 160° C. and a pressure of 3 MPA for 1 minute, and subsequently the substrates (decal) were removed.

### Comparative Example 1 (Hydrocarbon Membrane)

Anode and cathode layers were prepared according to the above description. A protective layer was not used. For the production of the CCM, the same hydrocarbon membrane type such as, for example, 1 having a thickness of 7 μm was used.

### Comparative Example 2 (PFSA Membrane)

Anode and cathode layers were prepared according to the above description. A protective layer was not used. For the production of the CCM, a PFSA membrane having a thickness of 12 μm was used.

### Comparative Example 3 (Hydrocarbon Membrane)

Anode and cathode layers were prepared according to the above description. A protective layer which only consisted of ionomer was used. For this, 1.40 g of D79-25BS (Solvay, PFSA ionomer dispersion, 25% by mass) and 7.77 g of organic solvents were mixed. Subsequently, the anode was overlaid with the help of a spiral doctor blade (wire diameter 8 μm) with the protective layer dispersion and dried for 5 minutes at 120° C. in a furnace. The resulting layer thickness of the protective layer was about 200 nm. For the production of the CCM, the same hydrocarbon membrane type such as in Example 1 having a thickness of 7 μm was used.

### Fuel Cell Test

Electrochemical tests were conducted with the help of a 38 cm² large PEM single cell equipped with graphitized serpentine flow plates. The single cell was thermally controlled by a thermocouple, wherein heat-resistant heating plates for heating and a ventilator for air cooling were used. The gases were wet using a moistener bubbler. The single cell was operated in counter flow principle.

All prepared CCM were provided with carbon-based gas diffusion layers on both sides of the membrane electrode units (CCMs). All CCM samples were provided with incompressible PTFE seals reinforced with glass fibers which resulted in a compression of 10% by volume of the GDL. Before the fuel depletion tests t of the MEA samples were conducted, the single cell was conditioned under hydrogen/air for 8 hours at 1 A/cm² and a pressure of 1.5 bar_{abs}. The temperature of the single cell T_{cell} was 80° C. and the moistener temperatures were 80° C. (anode) and 80° C. (cathode).

### Fuel Depletion Test (Cell Reversal)

The cells were subjected to an extended voltage reversal test which consisted of measures according to which a current of 0.2 A/cm² was drained, while the fuel cell was operated with air on the cathode side and nitrogen on the anode side (this simulates the fuel depletion case). The end of the test was achieved, when the mean cell voltage was fallen below −1.5 V. The time which was necessary for obtaining −1.5 V was called extended reversal tolerance time.

The content of carbon dioxide (CO₂) was measured at the outlet of the anode with the help of a Binos 100 2M sensor of the company Fisher-Rosemont GmbH & Co (Germany), wherein the measuring principle is based on the use of a nondispersive infrared (NDIR) photometer.

### Adhesion Test

For determining the adhesion, full-faced CCMs, i.e., the sizes of the anode and the cathode, and also the membrane were the same, with a size of 50×50 mm were prepared and placed in boiling water for 4 hours. In the instance of a good adhesion, the composite between both electrodes and the membrane remained stable. In the instance of a poor adhesion, one or both electrodes peeled off of the membrane.

The Example 1 comprising the protective layer between the anode and the membrane in a fuel cell configuration showed a considerably improved cell reversal tolerance in comparison to a CCM with a hydrocarbon membrane without such a protective layer (Comparative Example 1). Furthermore, Example 1 showed a cell reversal tolerance on the same level such as a corresponding CCM with a PFSA membrane without a protective layer. Comparative Example 3 comprised a protective layer between anode and membrane which did not contain a ceramic component. Due to the poor adhesion between the hydrocarbon membrane and the PFSA protective layer, a determination of the cell reversal tolerance was not possible.

TABLE 1

| | | Protective layer/ | Cell | |
|---|---|---|---|---|
| | | portion of | reversal | Adhe- |
| Example | Membrane | ceramic material | tolerance/h | sion |
| Example 1 | Hydrocarbon | Yes/52% by volume | 17.7 | Good |
| Example 2 | Hydrocarbon | Yes/31% by volume | Not tested | Good |
| Comparative | Hydrocarbon | No | 5.8 | Good |
| Example 1 | | | | |
| Comparative | PFSA | No | 17.7 | Good |
| Example 2 | | | | |
| Comparative | Hydrocarbon | Yes (pure | Not | Poor |
| Example 3 | | PFSA layer) | determinable | |
| | | | due to | |
| | | | peeling off | |
| | | | of electrode | |

1. A membrane electrode assembly comprising an anode, a cathode and a hydrocarbon membrane arranged between the anode and the cathode, further comprising a protective layer, which is arranged between the anode and the hydrocarbon membrane and/or between the cathode and the hydrocarbon membrane, wherein the protective layer comprises at least one ceramic material and a fluorine-containing fluorine-containing ionomer, wherein the ceramic material is distributed in the fluorine-containing fluorine-containing ionomer.

2. The membrane electrode assembly (1) according to claim 1, wherein the hydrocarbon membrane comprises sulfonated polyether ketones, sulfonated polyether ether ketones, sulfonated polyketone ketones, sulfonated polyphenylenes, sulfonated phenylated polyphenylenes and mixtures thereof, and/or
wherein a total volume of the ceramic material in the protective layer, based on the total volume of the protective layer, is at least 17% by volume and particularly at least 25% by volume and particularly at least 30% by volume, and/or
wherein a total volume of the ceramic material in the protective layer, based on the total volume of the protective layer, is less than 76% by volume, particularly less than 65% by volume and particularly less than 54% by volume, and/or
wherein a specific surface area of the ceramic material, measured according to BET, is 5 to 800 m²/g and particularly 20 to 500 m²/g, and/or
wherein the ceramic material has a weight loss of less than 2% by mass, when the ceramic material is subjected to a hydrogen stream of 3.3% by volume in argon for 12 hours at a temperature of 80° C., and/or
wherein the ceramic material is selected from at least one of oxides, nitrides, carbides, silicides, borides and mixtures thereof, of at least one, selected from silicon, tantalum, niobium, zinc, titanium, zirconium, cerium, tungsten, antimony or mixtures thereof, and is particularly selected from Nb₂O₅, Ta₂O₅, SiO₂, WO₃, ZrO₂ and mixtures thereof, and/or
wherein the equivalent weight of the proton-conductive polymer of the protective layer is smaller than 1050 g/mol and particularly lower than 950 g/mol and particularly smaller than 850 g/mol, and/or
wherein the layer thickness of the protective layer, measured by means of scanning electron microscopy, is lower than 10 μm, particularly lower than 5 μm and particularly lower than 3 μm, and/or
wherein the layer thickness of the protective layer is higher than or equal to 0.1 μm, particularly higher than or equal to 0.15 μm and particularly higher than or equal to 0.2 μm.

3. The membrane electrode assembly according to claim 1, wherein the cathode comprises at least one catalyst containing platinum, wherein a load of the cathode with catalyst, expressed in platinum weight per unit area of the cathode, is particularly 0.02 to 1 mg Pt/cm², particularly 0.05 to 0.6 mg Pt/cm² and particularly 0.1 to 0.4 mg Pt/cm², wherein the catalyst is particularly carried and wherein the carrier of the catalyst particularly comprises carbon.

4. The membrane electrode assembly according to claim 1, wherein the anode comprises at least one oxygen evolution catalyst, wherein the oxygen evolution catalyst comprises particularly iridium oxide or a mixed iridium-ruthenium oxide, and/or wherein the oxygen evolution catalyst is carried, particularly on a base metal oxide, particularly titanium oxide or niobium oxide.

5. The membrane electrode assembly according to claim 1, wherein the anode further comprises a hydrogen oxidation reaction catalyst, particularly a hydrogen oxidation reaction catalyst containing platinum, wherein the load of the anode with hydrogen oxidation catalyst containing platinum, expressed in platinum weight per unit area of the anode, is particularly 0.01 to 0.2 mg Pt/cm² and particularly 0.03 to 0.1 mg Pt/cm², wherein the hydrogen oxidation reaction catalyst is particularly carried on a carrier containing carbon.

6. The membrane electrode assembly according to claim 1, wherein the membrane electrode assembly is a water electrolysis cell membrane electrode assembly.

7. The membrane electrode assembly according to claim 1, wherein the membrane electrode assembly is a fuel cell membrane electrode assembly.

8. The membrane electrode assembly according to claim 6, wherein a load of the anode with catalyst, expressed in iridium weight per unit area of the anode, is 0.05 to 2 mg Ir/cm², particularly 0.1 to 1.5 mg Ir/cm² and particularly 0.2 to 1 mg Ir/cm².

9. The membrane electrode assembly according to claim 7, wherein a load of the anode with catalyst, expressed in iridium weight per unit area of the anode, is 0.005 to 0.05 mg Ir/cm², particularly 0.006 to 0.03 mg Ir/cm².

10. The membrane electrode assembly according to claim 6, wherein a layer thickness of the hydrocarbon membrane is 150 μm or less, or wherein the hydrocarbon membrane comprises a mechanical reinforcement and a layer thickness of the hydrocarbon membrane is 20 to 120 μm, particularly 30 to 100 μm.

11. The membrane electrode assembly according to claim 7, wherein a layer thickness of the hydrocarbon membrane is 20 μm or less, or wherein the hydrocarbon membrane comprises a mechanical reinforcement and a layer thickness of the hydrocarbon membrane is 5 to 15 μm.

12. A water electrolysis cell comprising a membrane electrode assembly according to claim 1.

13. A fuel cell comprising a membrane electrode assembly according to claim 1.

14. A method for the production of a membrane electrode assembly according to claim 1, comprising the steps:
preparing of a protective layer dispersion comprising at least one ceramic material and at least one fluorine-containing ionomer,
applying of the protective layer dispersion onto the anode or the cathode or the hydrocarbon membrane and
drying of the protective layer dispersion, wherein the protective layer is obtained, on the anode or the cathode or the hydrocarbon membrane.

15. A method for the production of a membrane electrode assembly according to claim 1, comprising the steps:
preparing of a protective layer dispersion comprising at least one ceramic material and at least one fluorine-containing ionomer,
applying of the protective layer dispersion onto a substrate,
drying of the protective layer dispersion, wherein the protective layer is prepared, and
transferring of the protective layer onto the anode or the cathode or the hydrocarbon membrane.

16. A method for the production of a membrane electrode assembly according to claim 1, comprising the steps:
preparing of a protective layer dispersion comprising at least one ceramic material and at least one fluorine-containing ionomer,
preparing of an anode dispersion or cathode dispersion,
applying of the anode dispersion or cathode dispersion onto a substrate,
applying of the protective layer dispersion onto the anode dispersion or the cathode dispersion,
drying of the dispersions, wherein the anode layer and the protective layer in the form of an anode layer/protective layer-assembly or the cathode layer and the protective layer in the form of a cathode layer/protective layer-assembly is prepared, and
transferring of the dried anode layer/protective layer-assembly or cathode layer/protective layer-assembly onto the hydrocarbon membrane,
the method optionally further comprising a step of laminating of the anode layer/protective layer-assembly and the hydrocarbon membrane.

17. A method for the production of a membrane electrode assembly according to claim 1, comprising the steps:
preparing of a protective layer dispersion comprising at least one ceramic material and at least one fluorine-containing ionomer,
preparing of an anode dispersion or cathode dispersion,
applying of the anode dispersion or the cathode dispersion onto a gas diffusion layer,
applying of the protective layer dispersion onto the anode dispersion or the cathode dispersion,
drying of the dispersions, wherein the anode layer and the protective layer in the form of an anode layer/protective layer/gas diffusion layer-assembly or the cathode layer and the protective layer in the form of a cathode layer/protective layer/gas diffusion layer-assembly is prepared, and
arranging of the dried anode layer/protective layer/gas diffusion layer-assembly or cathode layer/protective layer/gas diffusion layer-assembly on the hydrocarbon membrane.

18. A method for the production of a membrane electrode assembly according to claim 1, comprising the steps:
preparing of a protective layer dispersion comprising at least one ceramic material and at least one fluorine-containing ionomer,
preparing of an anode dispersion or cathode dispersion,
applying of the protective layer dispersion onto the hydrocarbon membrane,
applying of the anode dispersion or the cathode dispersion onto the protective layer dispersion, and
drying of the dispersions, wherein the anode layer or cathode layer and the protective layer are prepared.

19. The method according to claim 14, further comprising a step of tempering in a temperature range of 150 to 200° C.
